(19) United States
(12) Patent Application Publication
(10) Pub. No.: US 2007/0113250 A1
(43) Pub. Date: May 17, 2007

(54) On demand fantasy sports systems and methods

(76) Inventors: James D. Logan, Candia, NH (US); Mark Pascarella, Boston, MA (US); Dana Burd, Charlestown, MA (US); Olivier Karfis, Medford, MA (US); Eric Sackowitz, Haverill, MA (US)

Correspondence Address: FISH & NEAVE IP GROUP;ROPES & GRAY LLP, ONE INTERNATIONAL PLACE, BOSTON, MA, 02110-2624, US

(21) Appl. No.: 11/517,677

(22) Filed: Sep. 8, 2006

Related U.S. Application Data
(63) Continuation-in-part of application No. 10/060,001, filed on Jan. 29, 2002.
(63) Continuation-in-part of application No. 10/165,587, filed on Jun. 8, 2002.
(63) Continuation-in-part of application No. 10/767,930, filed on Jan. 29, 2004.
(60) Provisional application No. 60/715,041, filed on Sep. 8, 2005.

(51) Int. Cl. H04N 5/445; H04N 7/10; H04N 7/025; H04N 7/16; G06F 13/00; G06F 3/00

(52) U.S. Cl. 725/46; 725/135; 725/34; 725/35

(57) ABSTRACT

A method for enhancing a fantasy sports game with recorded sports broadcasts includes the steps of receiving video programs depicting sports-related events, storing the video programs, associating to a plurality of segments of the video programs attribute data that identifies for a segment of the plurality of segments at least one of a plurality of persons related to a portion of the sports-related events depicted in the segment of the plurality of segments, transmitting to a presentation device for display a player guide containing at least one of the plurality of persons, receiving from a user of the presentation device a video request related to a particular person contained in the player guide, retrieving from the plurality of segments a particular segment associated with attribute data that identifies the particular person, and transmitting the particular segment to the presentation device for display.

### CROSS REFERENCE TO RELATED APPLICATIONS

This application claims priority to and the benefit of U.S. Provisional Patent Application Ser. No. 60/715,041 filed Sep. 8, 2005 and entitled “On Demand Fantasy Sports Games.”

This application is also continuation in part of and claims the benefit of U.S. application Ser. No. 10/060,001 filed by James D. Logan et al. on Jan. 29, 2002) entitled “Audio and Video Program Recording, Editing and Playback Systems Using Metadata” and published as U.S. patent application Publication No. 2002-0120925 on Aug. 29, 2002.

This application is also a continuation in part of and claims the benefit of U.S. application Ser. No. 10/165,587 filed by James D. Logan et al. on Jun. 8, 2002 entitled “Audio and Video Program Recording, Editing and Playback Systems Using Metadata” and published as U.S. patent application Publication No. 2003/0093790 A1 on May 15, 2003.

This application is also a continuation in part of and claims the benefit of U.S. application Ser. No. 10/767,930 filed by James D. Logan et al. on Jan. 29, 2004 entitled “Methods and Apparatus for Recording and Replaying Sports Broadcasts” and published as U.S. patent application Publication No. 2005/0005308 A1 on Jan. 6, 2005.

The disclosure of each of the foregoing applications is incorporated herein by reference.

### BACKGROUND

The present invention belongs to a family of related systems that use metadata to control the playback of broadcast programming as disclosed in the previously issued patents and published patent applications summarized below. The disclosures of each of the following patents and published applications are hereby incorporated herein by reference.

U.S. Reissue Pat. No. Re 36,801 issued to James D. Logan et al. on Aug. 1, 2000 entitled “Time delayed digital video system using concurrent recording and playback” describes a mechanism for continually storing live television or radio broadcast programs in an addressable digital memory and playing back the broadcast program after a variable delay period under the control of the viewer, permitting the viewer to pause, replay, and fast-forward (skip) live programming.

U.S. Pat. Nos. 5,892,536, 5,986,692, and 7,055,166 issued to James D. Logan et al. describe systems which employ metadata to selectively store, manipulate and playback broadcast programming. Some of the arrangements and features disclosed in those two patents may be summarized as follows:

1. A remote editing station, which may be at the broadcast facility or at a remote location, classifies, describes or otherwise identifies individual segments of broadcast programming and sends metadata (sometimes referred to as “markup data”) identifying and describing those segments to a remote client receiver. For example, the markup data may identify individual segments by specifying the source and the time of the original broadcast, or by specifying some other unique characteristic of the broadcast signal. The program segments may be TV, radio, or Internet programs, or portions of programs, including individual songs, advertisements, or scenes.

2. The communication link used to transmit the metadata to the client may take one of several forms, including the Internet, a dialup telephone link, the communications pathway used to carry the broadcast signals to the client, or other forms of communication used to transport the metadata to the client.

3. At the client receiver, the metadata is used to identify particular program segments that may then be manipulated in one or more of a variety of ways. For example, the metadata may be used to selectively play back or record particular segments desired by the user; to re-sequence the identified segments into a different time order; to “edit-out” undesired portions of identified segments; to splice new information, such as computer text or advertising, into identified segments for rendering with the program materials, or to substitute different material (e.g. dubbing in acceptable audio to replace profanity to make programming more acceptable to minors).

4. The client receives and locally stores incoming broadcast programming and uses the markup data to identify desired segments within the stored program materials. The local storage mechanism may advantageously include means for concurrently recording live broadcasting while replaying a delayed version of the previously recorded programming as described in U.S. Reissue Pat. No. 36,801 issued to James D. Logan et al.

5. The markup data can provide a detailed “electronic program guide” to the broadcast programming previously received and stored in a personal video recorder (PVR) or an audio storage device, permitting the user to selectively play back a desired segment or portion of the programming previously recorded.

6. The markup data may be used to create a recorded collection of desired segments extracted from the buffered broadcast, allowing the desired segments to be saved while the remainder of the buffered materials is discarded to conserve recording space.

7. Special markup signals may be selectively sent to individual subscribers based on his or her indicated preferences so that only preferred program segments are identified and processed. For example, a subscriber might request markup data only for sports and news.

U.S. Pat. Nos. 5,732,216, and 6,199,076, and co-pending application Ser. No. 09/782,546 filed on Feb. 13, 2001, by James D. Logan et al. describe a program distribution system which incorporates the following features:

1. A host system organizes and transmits program segments to client subscriber locations.

2. A scheduling file of metadata (a “playlist”) schedules the content and sequence of a playback session, which may then be modified by the user.

3. The content of the scheduled programming is varied in accordance with preferences associated with each subscriber.

4. Program segments are associated with descriptive subject matter segments, and the subject matter segments may be used to generate both text and audio cataloging presentations to enable the user to more easily identify and select desirable programming.

5. A playback unit at the subscriber location reproduces the program segments received from the host and includes mechanisms for interactively navigating among the program segments, including jumping from segment to segment in both forward and reverse directions.

6. A usage log is compiled to record the subscriber's use of the available program materials, to return data to the host for billing, to adaptively modify the subscriber's preferences based on actual usage, and to send subscriber-generated comments and requests to the host for processing.

7. Voice input and control mechanisms included in the player allow the user to perform hands-free navigation of the program materials and to dictate comments and messages, which are returned to the host for retransmission to other subscribers.

8. The program segments sent to each subscriber may include advertising materials, which the user can selectively play to obtain credits against the subscriber fee.

U.S. patent application Publication No. 2002/0120925 A1 published on Aug. 29, 2002 (based U.S. application Ser. No. 10/060,001 filed by James D. Logan et al. on Jan. 29, 2002) entitled “Audio and Video Program Recording, Editing and Playback Systems Using Metadata” describes structures and functions used to provide metadata control over the recoding, editing and playback of audio and video programming, including the use of mechanisms at the user's location for creating metadata which may be used in combination with metadata provided by an external source, for editing metadata in various ways at the user's location, for automatically responding to user activity to generate new metadata which characterizes the user's preferences and which serves to automatically identify and describe (or rate) programming segments, and for responding in numerous ways to the available metadata to enhance the utility and enjoyment of available broadcast materials.

U.S. patent application Publication No. 2003/0093790 A1 published on May 15, 2003 (based U.S. application Ser. No. 10/165,587 filed by James D. Logan et al. on Jun. 8, 2002) entitled “Audio and Video Program Recording, Editing and Playback Systems Using Metadata” describes systems for utilizing metadata created either at a central location for shared use by connected users, or at each individual user's location, to enhance user's enjoyment of available broadcast programming content. A variety of mechanisms are employed for automatically and manually identifying and designating programming segments, associating descriptive metadata with the identified segments, distributing the metadata for use at client locations, and using the supplied metadata to selectively record and playback desired programming.

U.S. patent application Publication No. 2005/0005308 A1 published on Jan. 6, 2005 (based U.S. application Ser. No. 10/767,930 filed by James D. Logan et al. on Jan. 29, 2004) entitled “Methods and Apparatus for Recording and Replaying Sports Broadcasts” describes systems for replaying a broadcast sports event using a video on demand or personal video recording system. Metadata is created that subdivides the original broadcast into segments, and associates descriptive information with each segment. Playlists that specify an ordered subsequence of the sequence may be selected and used to present a variety of expanded or condensed versions of the sporting event to a viewer. Navigation controls including segment lists, specially formatted screen displays, and special functions under the control of a user-operated remote control, facilitate the interactive selection and control of the presentation.

### SUMMARY

The invention describes methods and systems for displaying sports-related events in an interactive fashion according to a viewer participating in a fantasy sports game. One aspect of the invention includes a method for enhancing a fantasy sports game with recorded sports broadcasts. The method comprises receiving video programs depicting sports-related events, storing the video programs, associating to a plurality of segments of the video programs attribute data that identifies for a segment of the plurality of segments at least one of a plurality of persons related to a portion of the sports-related events depicted in the segment of the plurality of segments, transmitting to a presentation device for display a player guide containing at least one of the plurality of persons, receiving from a user of the presentation device a video request related to a particular person contained in the player guide, retrieving from the plurality of segments a particular segment associated with attribute data that identifies the particular person, and transmitting the particular segment to the presentation device for display.

The particular person can be at least one of participating, speaking, and being mentioned, during that portion of the sports-related event depicted in the particular segment. The sports-related event can be at least one of a live sports game, a sports news show, a sports analysis show, an interview, a pre-game show, a post-game show, and a sports practice session. The attribute data can identify at least one of a title of the segment, a team name, a second particular person related to that portion of the sports-related event depicted in the segment, a date when the sports-related event occurred, a time period in which that portion of the sports-related event depicted in the segment occurred, an event that occurs during that portion of the sports-related event depicted in the segment, and a number representing points corresponding to a person related to that portion of the sports-related event depicted in the segment, the points corresponding to the fantasy sports game. The sports-related event can be related to, for example and without limitation, at least one of football, baseball, basketball, hockey, golf, tennis, soccer, and auto racing. The player guide can contain descriptions relevant to the persons related to the sports-related events, where the descriptions can include at least one of sports statistics, position played, team played on, points corresponding to the fantasy sports game, and playlists available for displaying on the presentation device. The video programs can be stored in at least one of a cable television headend, an internet accessible database, a mobile phone network accessible database, a personal video recorder, and a hard disk drive. The fantasy sports game can simulate at least one of a sports game, a draft for a sports league, and a video game.

In one embodiment, the method stores a team list representing a fantasy sports team formed by the user for the fantasy sports game including at least one of the plurality of persons. The method can receive from the user a selection indicating that the particular person be added to the team list, transmit the team list to a fantasy sports league server operating the fantasy sports game, receive the team list from a fantasy sports league server operating the fantasy sports game, and/or create a playlist that includes at least one of the plurality of segments, where each person on the team list is identified by attribute data associated with at least one segment included in the playlist, and transmitting to the presentation device for display a segment guide listing the at least one segment included in the playlist.

In another embodiment, the method creates a playlist that corresponds to a playlist condition and includes segments of the plurality of segments, where the segments included in the playlist are each associated with attribute data that satisfies the playlist condition, and transmits to the presentation device for display a segment guide listing the segment included in the playlist. The playlist condition can identify at least one attribute datum associated with each of the segments included in the playlist. The method can receive from the user a segment request related to one of the segments listed in the segment guide, transmit to the presentation device for display the segment related to the segment request, receive from the user a playlist request where the playlist condition is based on the playlist request, and store user preferences, where the playlist condition is based on the user preferences and the user preferences can indicate a ranking of sports-related events.

In another embodiment, the method stores video programs having attribute data associated to segments of the video programs at a rate of about once a week during a sports season corresponding to the fantasy sports game.

### BRIEF DESCRIPTION OF THE DRAWINGS

In the detailed description which follows, reference will be made to the attached drawings, in which:

FIG. 1 depicts an illustrative system for providing video to users participating in a fantasy sports game;

FIG. 2 depicts an illustrative flowchart for providing video to users participating in a fantasy sports game;

FIG. 3 depicts an illustrative flowchart corresponding to how a user may navigate a player guide to view video;

FIG. 4 depicts an illustrative screenshot of a Welcome page of a player guide;

FIGS. 5A and 5B depict illustrative screenshots of, respectively, a Welcome page and a Fantasy Team page of a player guide;

FIG. 6 depicts an illustrative screenshot of a Player Selection page of a player guide;

FIG. 7 depicts an illustrative screenshot of a Player Selection page of a player guide;

FIG. 8 depicts an illustrative screenshot of a Scout Player page of a player guide;

FIG. 9 depicts an illustrative screenshot of a Scout Player page of a player guide;

FIGS. 10A, 10B, and 10C depict illustrative screenshots of a player guide playing segments of a playlist;

FIG. 11A and 11B depict illustrative screenshots of a player guide playing segments of a playlist; and

FIG. 12 depicts an illustrative screenshot of a Watch Team Index page of a player guide.

### DETAILED DESCRIPTION

The system for enhancing fantasy sports games by displaying sports programming may be used on a variety of different platforms:

1. A Video on Demand (VOD) system with storage at the headend and where viewing would be totally time-shifted; that is, the sports programming would be stored in its entirety in a VOD video server before being made available to subscribers.

2. A networked Personal Video Recording (nPVR) system where the storage is again at the headend and viewing might be only partially time-shifted; that is, the game may still be in progress as the viewer begins to view the game, normally from the start, on a delayed basis.

3. A Personal Video Recorder (PVR), where the storage is local and the game may be partially or totally time-shifted.

4. A Satellite Video on Demand system where content is specifically broadcast by a satellite in order to be placed in storage at the subscriber's location, for example in a PVR incorporated into a satellite receiver. The satellite provider may choose which programs are downloaded, often during nighttime hours so that they will be available to subscribers on demand the following day (and thereafter until deleted).

Each of the foregoing platforms is described in more detail in U.S. patent application Publication 2003/0093790 A1 published on May 15, 2003. The system may also be available via the internet or over a wireless device such as a mobile phone or hand-held media device. For a television system, the user may use the remote control to generate content navigation and selection commands. For a system available over the internet, the user may access the system by visiting a website, for example through a website of the operator of a fantasy sports league, and/or through software installed on a personal computer that is capable of accessing the internet. Similarly, a wireless device may access the internet to access the system, where the system is capable of providing pages and interfaces configured for use on a smaller screen. For any possible system, the user may first select a playlist that presents selected segments of sports video programs, jump from segment to segment in either direction, or jump to any desired segment listed in the displayed segment guide, and thereby interactively control the presentation of video content.

One aspect of the invention includes methods and apparatus for displaying sports-related events in an interactive fashion according to input from a viewer. Although many of the techniques are depicted and described with respect to football, it should be understood that most of these techniques can be applied to other sports events as well, including without limitation baseball, basketball, hockey, boxing, golf, tennis, soccer, and auto racing.

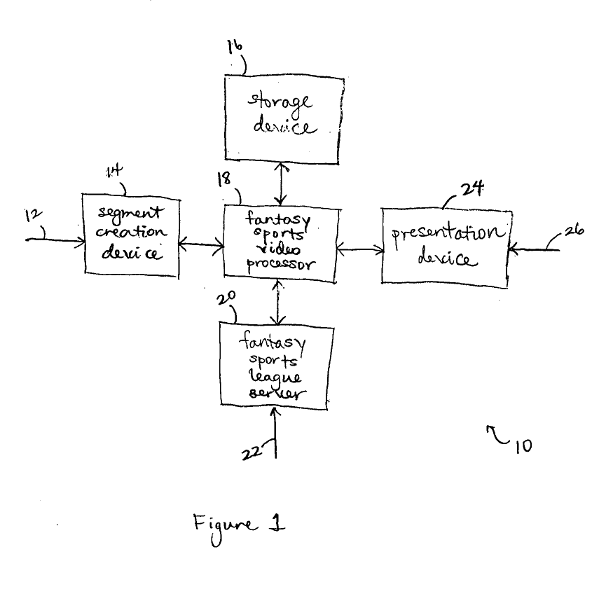

FIG. 1 depicts an illustrative system 10 for providing video to users participating in a fantasy sports game. A video program that a user may be interested in viewing may be received by a segment creation device 14, a storage device 16, and/or a fantasy sports video processor 18. The video program can depict any event related to sports, such as a sports game, a sports practice session, a sports news show, a sports analysis show, pre-game or post-game broadcasts, interviews, and press conferences, and can be intended for display on a television, a computer screen, and/or a wireless device such as a mobile phone or a hand-held media player. A user may indicate preferences or requests by providing input 22 and 26 to a presentation device 24 and/or a fantasy sports league server 20. User input can include selections for a fantasy sports team, video requests, and/or user preferences. The fantasy sports video processor 18 can communicate with the segment creation device 14, the storage device 16, and the fantasy sports league server 20 to provide video segments and/or programs to the presentation device 24.

The segment creation device 14 can receive the video program via a channel 12 and generate metadata that corresponds to the received video program. The channel 12 can include a broadcast cable channel, a channel broadcast from a satellite, and/or a channel over an internet. As described in the patents and applications identified in the “Background” section above, metadata may be created by human editors or by automated techniques to identify the starting and ending points of segments of the video program, where the segments of an event may overlap. Metadata can include attribute data such as text labels or other descriptive information characterizing individual segments and their contents. Metadata may be used to selectively display selected sequences of segments for the user, for example by selecting and ordering sequences of segments according to user input. Segments may be described with short text labels (called “slugs,” “tags,” or “labels”) which may be displayed as a segment “index” or “guide” on the television monitor.

The storage device 16 can be one of many storage devices that can be accessed by the fantasy sports video processor 18 and can store video programs, metadata including segments and corresponding attribute data, and/or user profile information such as a fantasy sports team and preferences relating to video content. Exemplary storage devices include a cable television headend, an internet accessible database, a mobile phone network accessible database, a personal video recorder, a hard disk drive, or a combination thereof. The system 10 can have multiple storage devices that are of multiple types, for example a cable television that is capable of accessing the internet can use both a headend and an internet database for storage.

The fantasy sports league server 20 can operate a fantasy sports league including accepting user input 22, holding a draft at the beginning of the sports season, maintaining team rosters of fantasy sports teams of users, and calculating and assigning points during the sports season according to rules of the fantasy sports league. The fantasy sports league server 20 can communicate team rosters of users, rules guiding team rosters and points, and players eligible for inclusion in team rosters to the fantasy sports video processor 18. The fantasy sport league server 20 can also receive and update changes to team rosters of users from the fantasy sports video processor 18 both during a draft and during a season, for example to execute player trades and substitutions.

The presentation device 24 can receive from the fantasy sports video processor 18 videos or segments of videos to display to the user. In addition, the presentation device 24 can display a guide to the user which enables the user to selectively control which segments, or which sequence of segments (playlists), are displayed. Any other menus or interfaces for managing a fantasy sports team, requesting a segment or playlist of segments, or navigating segments of a playlist may also be displayed. Guides, menus, or other interface options that are displayed may be based on information received from the fantasy sports video processor 18, such as the user's fantasy team roster or a user profile including user preferences, as well as user input such as search terms.

The fantasy sports video processor 18 can coordinate video, associated metadata, fantasy sports team rosters, and other information from the segment creation device 14, the storage device 16, and the fantasy sports league server 20 to communicate navigable segments of video to the presentation device 24 for display. The segments can be selected and ordered to form playlists by the fantasy sports video processor 18, either to correspond to a player guide that will be displayed to the user via the presentation device 24 and/or in response to requests and preferences received from the presentation device 24 that are based on user input 26. The user can access the player guide, or otherwise make video requests, to locate and view video segments which aid the user in scouting and researching players that the user is considering for inclusion in a fantasy sports team. This scouting and research can be performed prior to the sports season, prior to a draft for the fantasy sports league, and/or during the season. The user may also request video during the season that provides a visual summary of the performance of the user's fantasy team, either recently or for the entire season. Alternatively, if the user is participating in a fantasy game that simulates the progress of a game between real or fantasy teams, such as games made by Strat-O-Matic of Glen Head, New York or video games like MADDEN NFL offered by EA Sports of Redwood City, Calif., the fantasy sports video processor 18 can retrieve and transmit for display segments of video that reflect the simulated progress of the fantasy game. For example, if during the progress of the simulated game, a particular player performs a specific type of play, the processor 18 can enhance the simulated game by retrieving a video segment depicting that particular player performing that specific type of play.

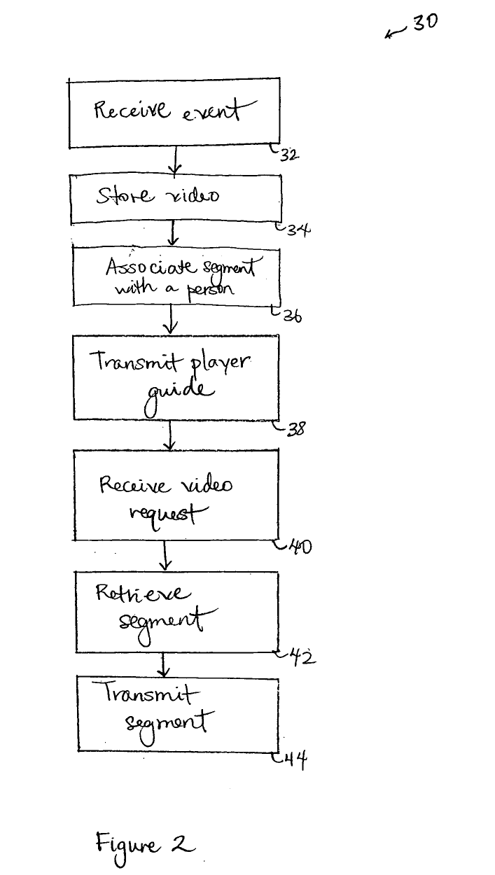

FIG. 2 depicts an illustrative flowchart 30 for providing video to users participating in a fantasy sports game. Step 32 receives a video of a sports-related event which step 34 can store. Step 36 can generate metadata that corresponds to the video, including associating segments of the video with attribute data that summarizes, describes, and/or characterizes the portions of the sports-related event depicted in the respective segments of the video. Step 38 transmits a player guide, including navigable menus of persons eligible for inclusion in a team roster according to rules of the fantasy sports game, which a user can use to request video. Step 40 receives the video request from the user, step 42 retrieves segments of video in response to the video request using metadata generated by step 36, and step 44 transmits the retrieved segments for display to the user.

Step 32 receives videos of sports-related events that are related to at least one player eligible for inclusion in a team roster of the fantasy sports game. The player that is related to an event may be participating in the event, speaking during the event, or being discussed during the event. Examples of how a person can be related to an event include the player playing in a live sports game or practice session, giving an interview or press conference, being the topic of discussion on a sports news or analysis show, and participating in any pre-game or post-game activities or broadcasts. Step 34 can store the received videos for later retrieval in any of the storage devices described with respect to FIG. 1, including a combination of different storage devices.

Step 36 generates metadata corresponding to the received videos that allows a user to retrieve segments of the videos that satisfy specific criteria. Metadata can be automatically or manually generated from a video that may or may not have been stored by step 34. Metadata can include the location, duration, and associated attribute data of a segment of a received video. For example, metadata can define a segment depicting a scoring play in a sports game and include attribute data that describes the play, key players involved in the play, when the play occurred, and corresponding points for the fantasy sports game earned by those players for the play. In another example, metadata can define a segment of a sports show or press conference devoted to analyzing or discussing a specific player and include attribute data that describes a summary of the discussion, the specific player who is discussed, and the source who is providing the discussion (e.g., SportsCenter, the player's coach, another player from the same or rival team).

Step 38 transmits a player guide for display to a user. The player guide includes players that are eligible for inclusion in a fantasy team roster according to the rules of the fantasy sports league running the fantasy sports game and may be organized in menus according to position, team, and/or points earned in a fantasy sports game either currently or in a previous season. The user may navigate menus of the player guide to create and/or update a fantasy team roster and to request information and/or video segments related to a player included in the player guide. The player guide may also allow the user, when requesting video segments, to indicate specific criteria that the video segments must satisfy.

Step 40 receives a video segment request from the user. The request may specify that the video segments be related to a specific player, position, team, and/or play (e.g., touchdowns, passes, runs, alley oops, dunks). The request may also specify that the video segments be limited to a specific time period such as a specific week of the sports season or the previous year, depict plays that earn points in the fantasy sports game, and/or include discussion of a specific player. The request may also specify that the video segments be related to players who are (or are not) scheduled to play in some upcoming time period according to a season schedule, are (or are not) on an injured list, who are of a specific depth level on their team (e.g., first string, second string, starter), and/or by any other attribute that describes a player. The request may also specify that video segments be ranked according to some metric, such as number of yards gained or number of fantasy points. The request may be received via the user indicating a selection from the player guide or entering specific criteria such as a search query or preferences of a user profile.

Step 42 retrieves at least one segment in response to the request received in step 40. For some requests a playlist of segments may already have been created, for example to correspond to possible selections from the player guide. Playlists may also be generated in response to requests, in which case step 42 may retrieve segments that satisfy specific criteria and order or rank the retrieved segments according to their relevance to the specific criteria and/or user preferences. The specific criteria may be automatically generated by the player guide or be based on user input.

Step 44 transmits the playlist of segments retrieved by step 42 as a segment guide to be displayed to the user, who can select a segment included in the playlist to view. Step 44 can then transmit the selected segment for display to the user. The segment guide can be navigable, where the user can skip to any segment in the segment guide's playlist, including the previous or next segment.

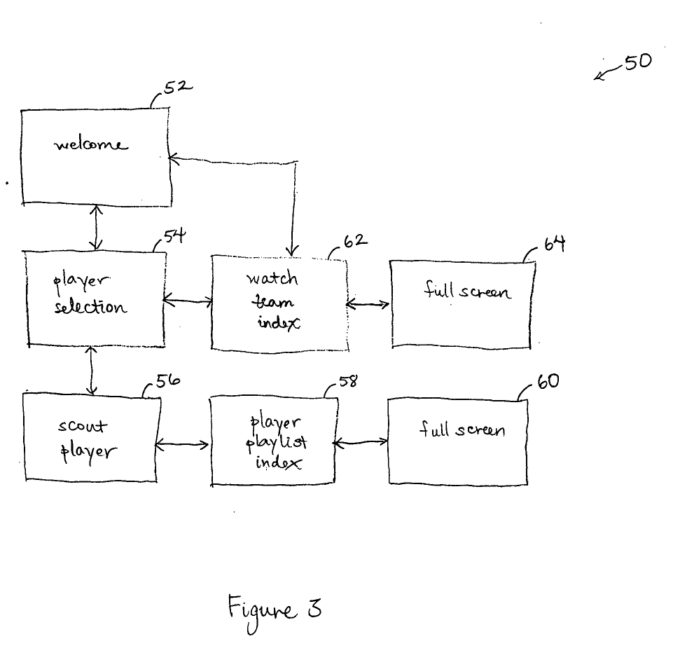

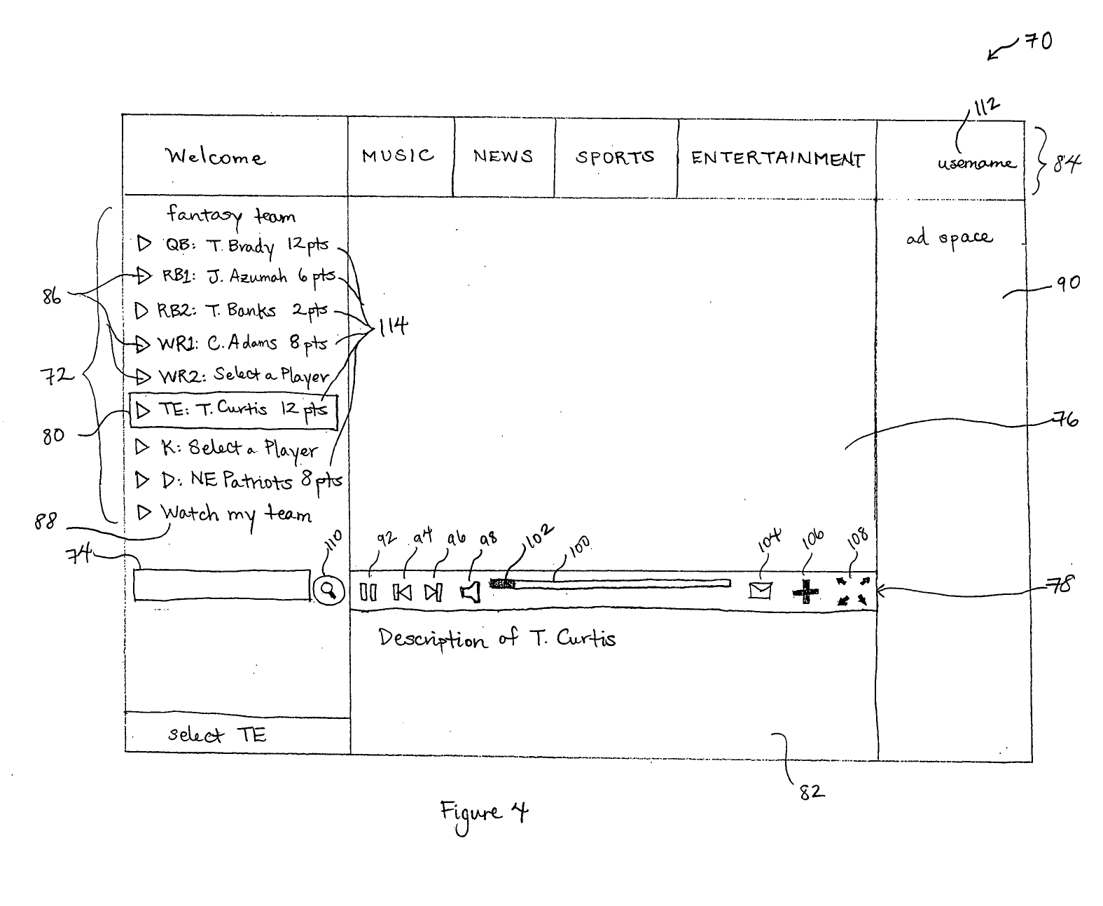

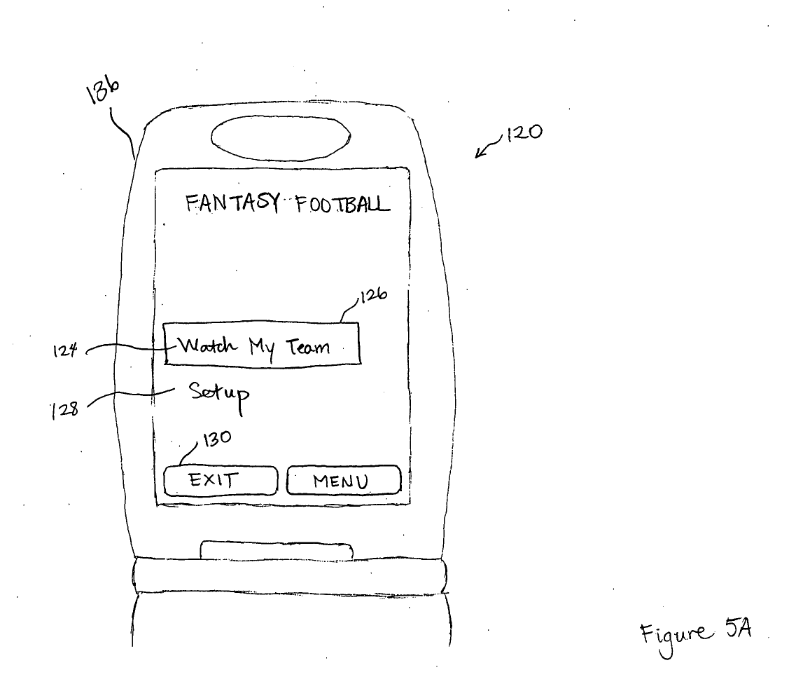

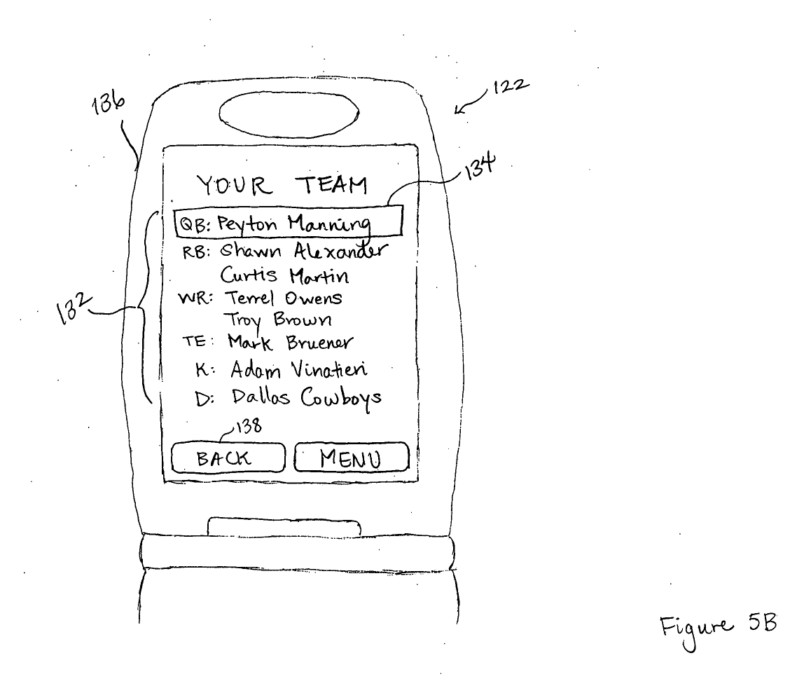

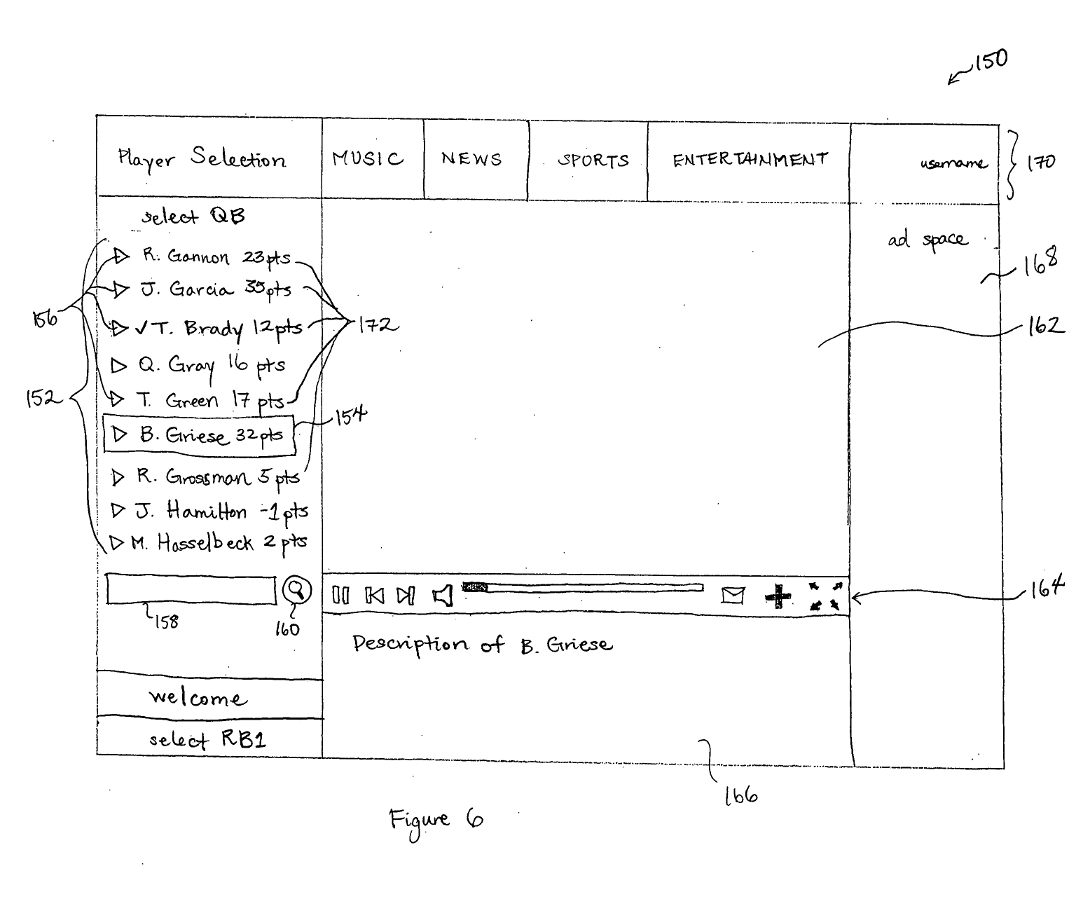

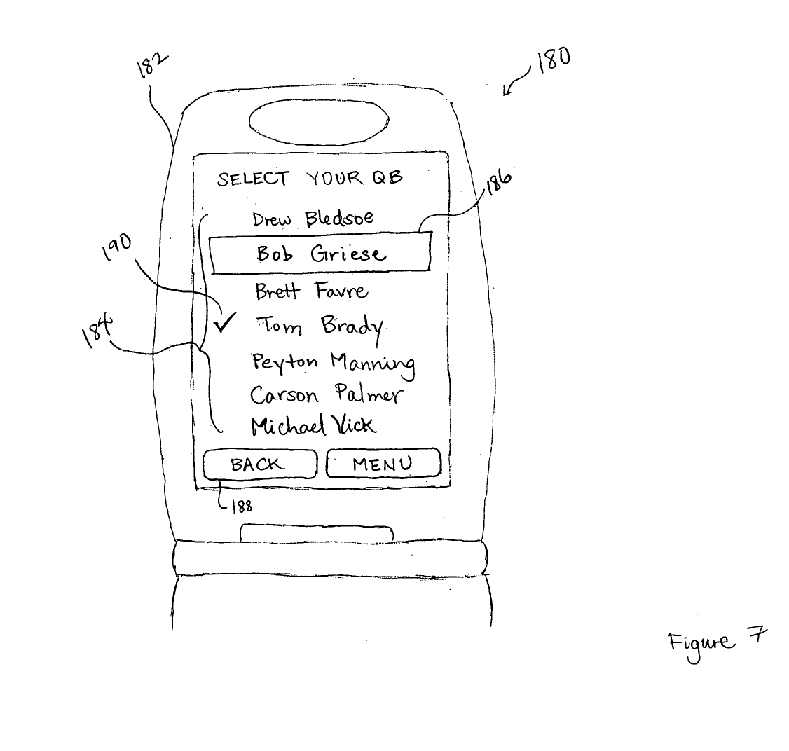

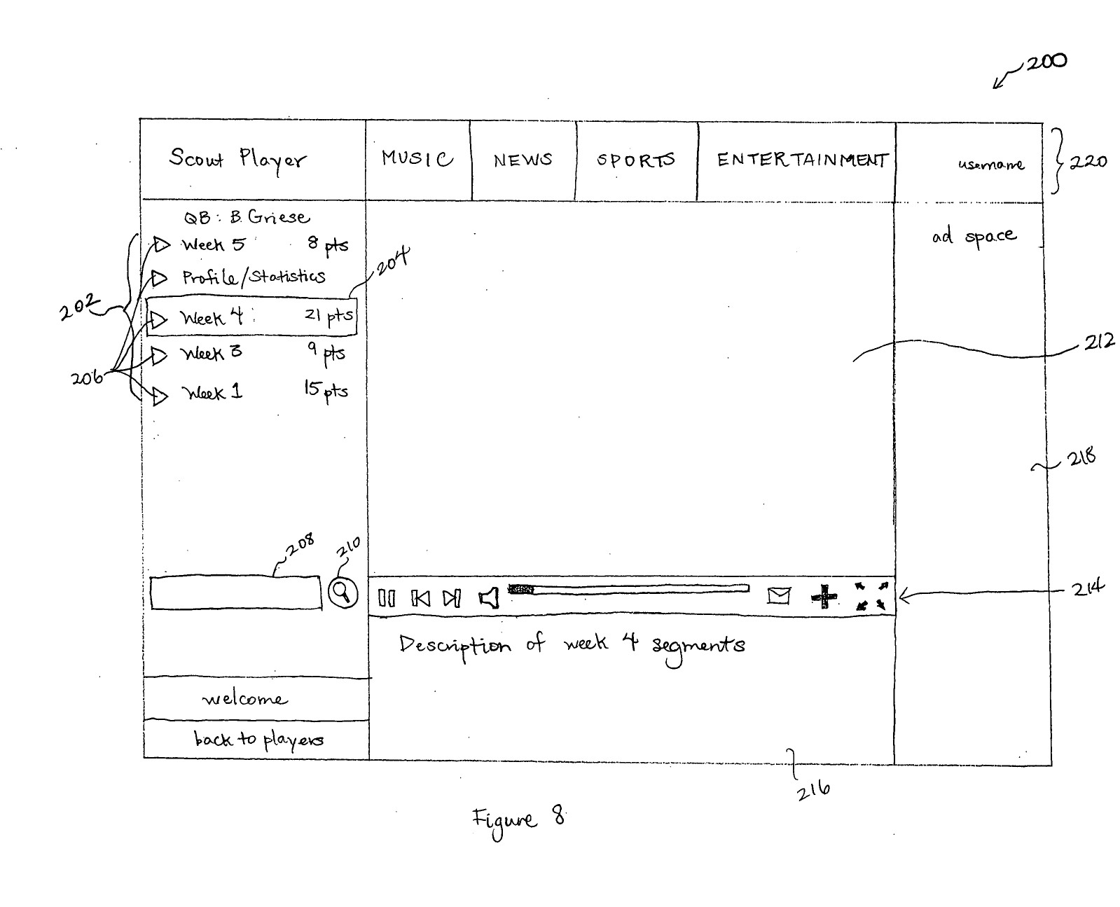

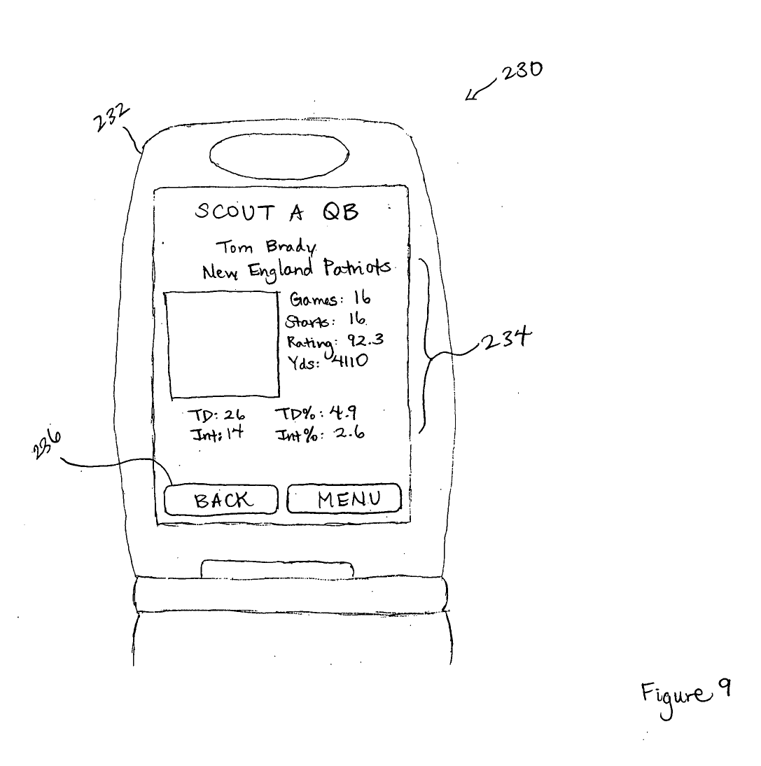

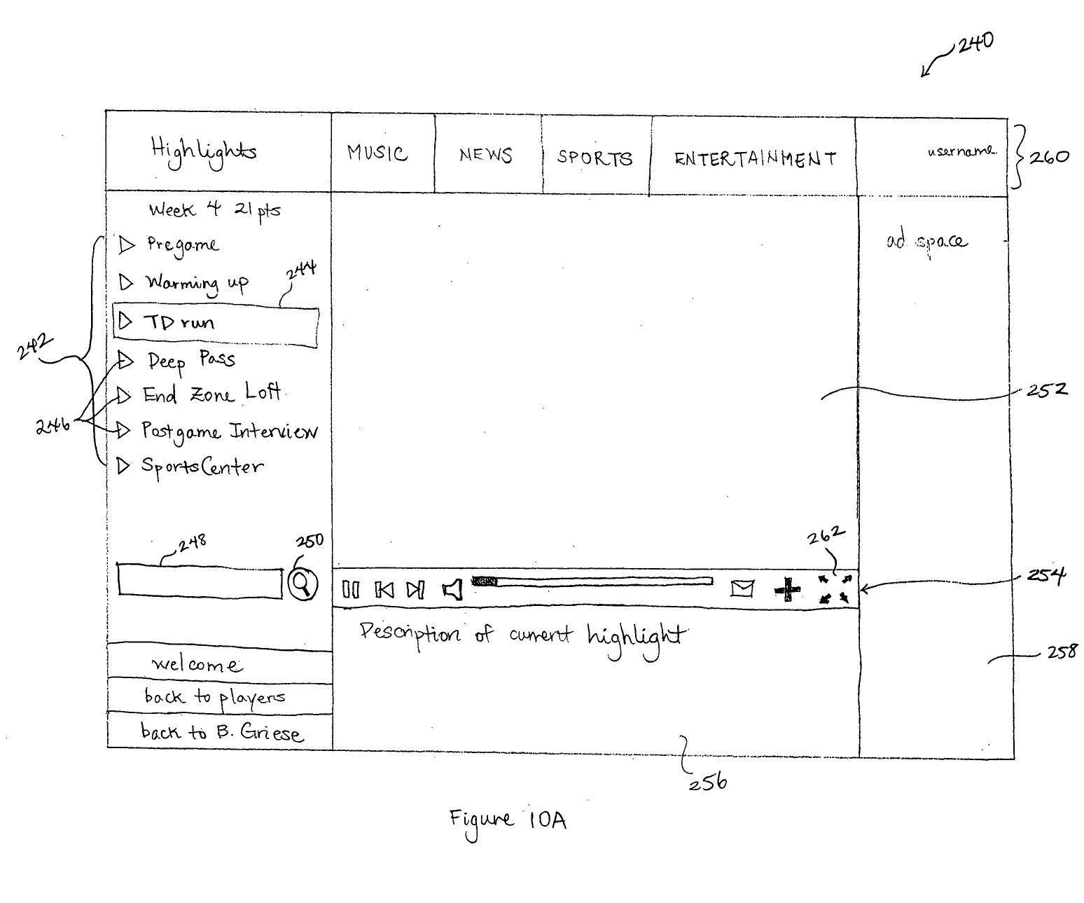

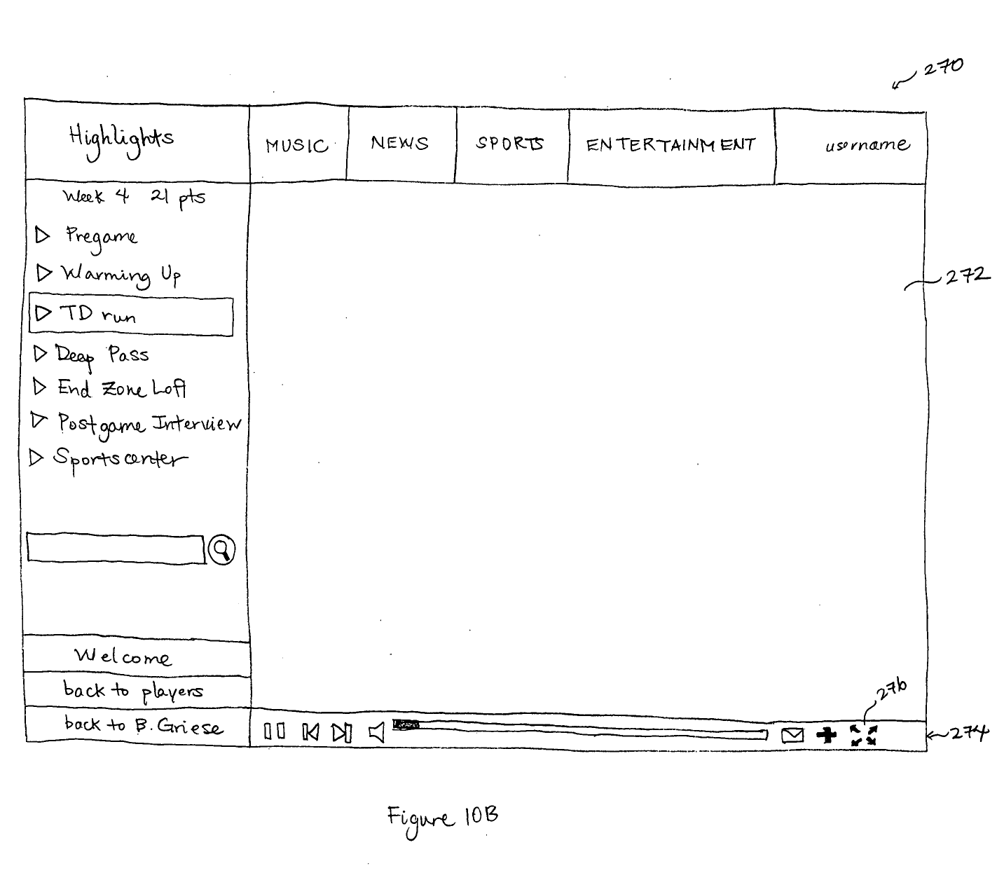

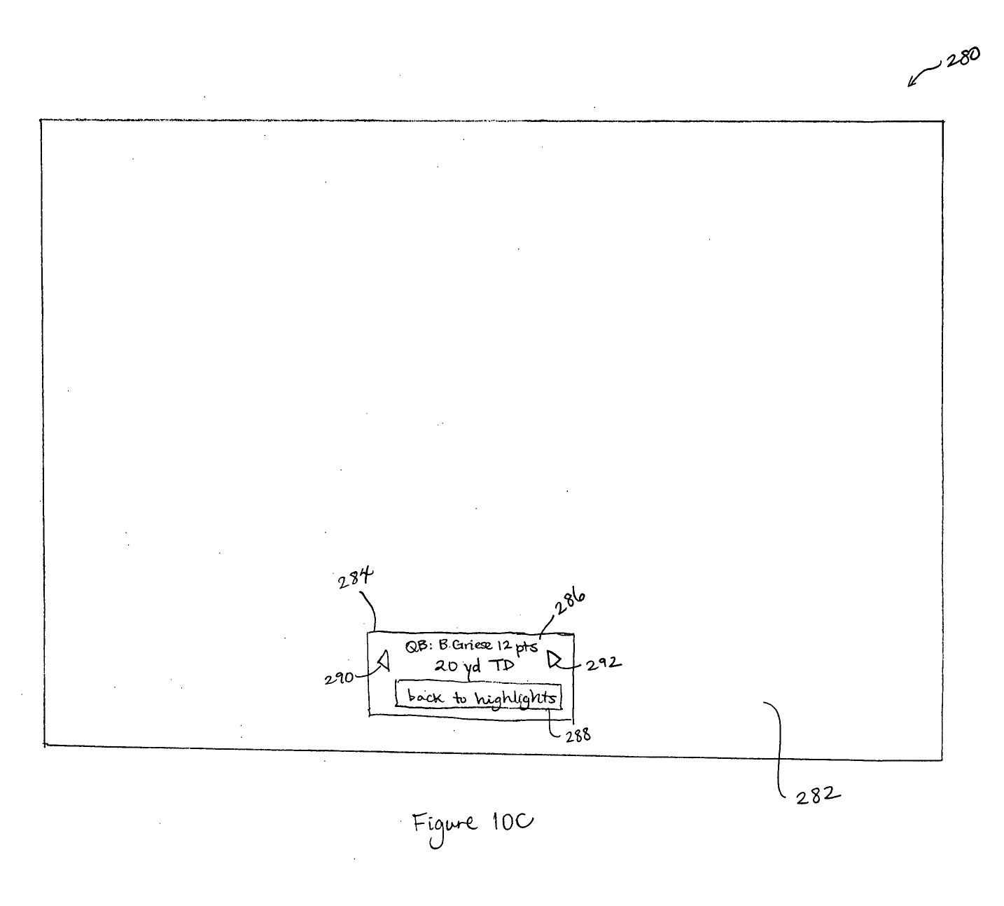

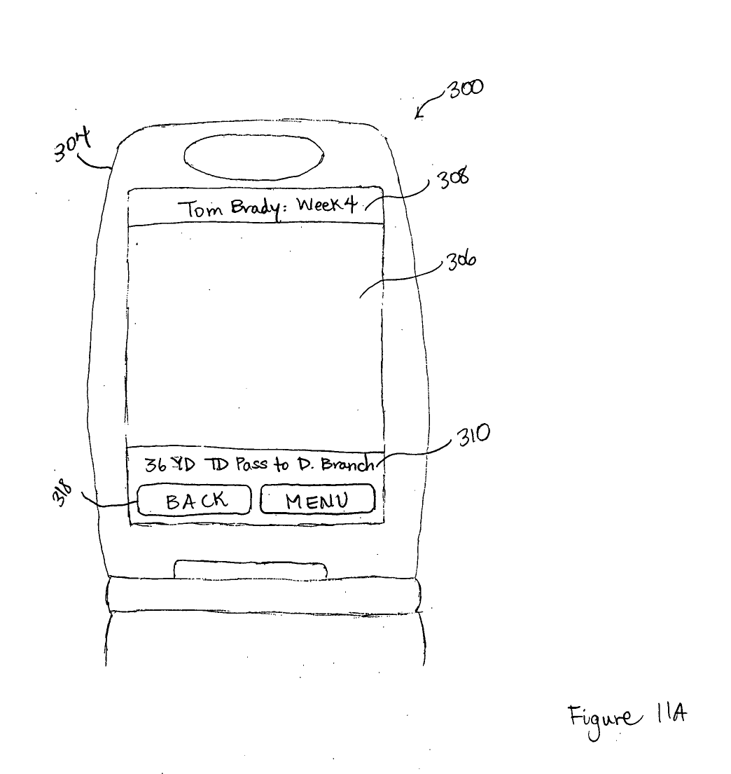

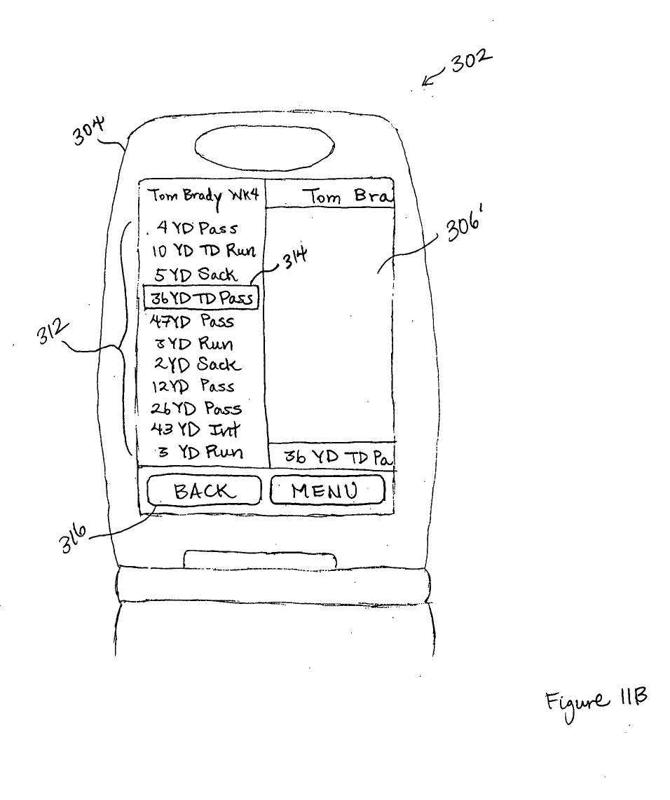

FIG. 3 depicts an illustrative flowchart 50 corresponding to how a user may navigate a player guide displayed on a presentation device, such as the presentation device 24 of FIG. 1, and provided according to a method such as that depicted in FIG. 2. The first page of a player guide may be a Welcome page 52, as described further in relation to FIGS. 4, 5A, and 5B, from which the user may visit a Player Selection page 54 to create or update the user's fantasy sports team roster, as described further in relation to FIGS. 6 and 7. To assist in selecting players for the team roster, the user may visit a Scout Player page 56 offering playlists relevant to the player being considered for inclusion on the team roster, as described further in relation to FIGS. 8 and 9. Selecting a playlist allows the user to visit a Player Playlist Index page 58 that displays a segment guide for the playlist, as described further in relation to FIGS. 10A and 11B. From this page the user may opt to view segments in a larger screen, such as a Full Screen mode 60, that may or may not display the segment guide, as described further in relation to FIGS. 10B, 10C, and 11A.

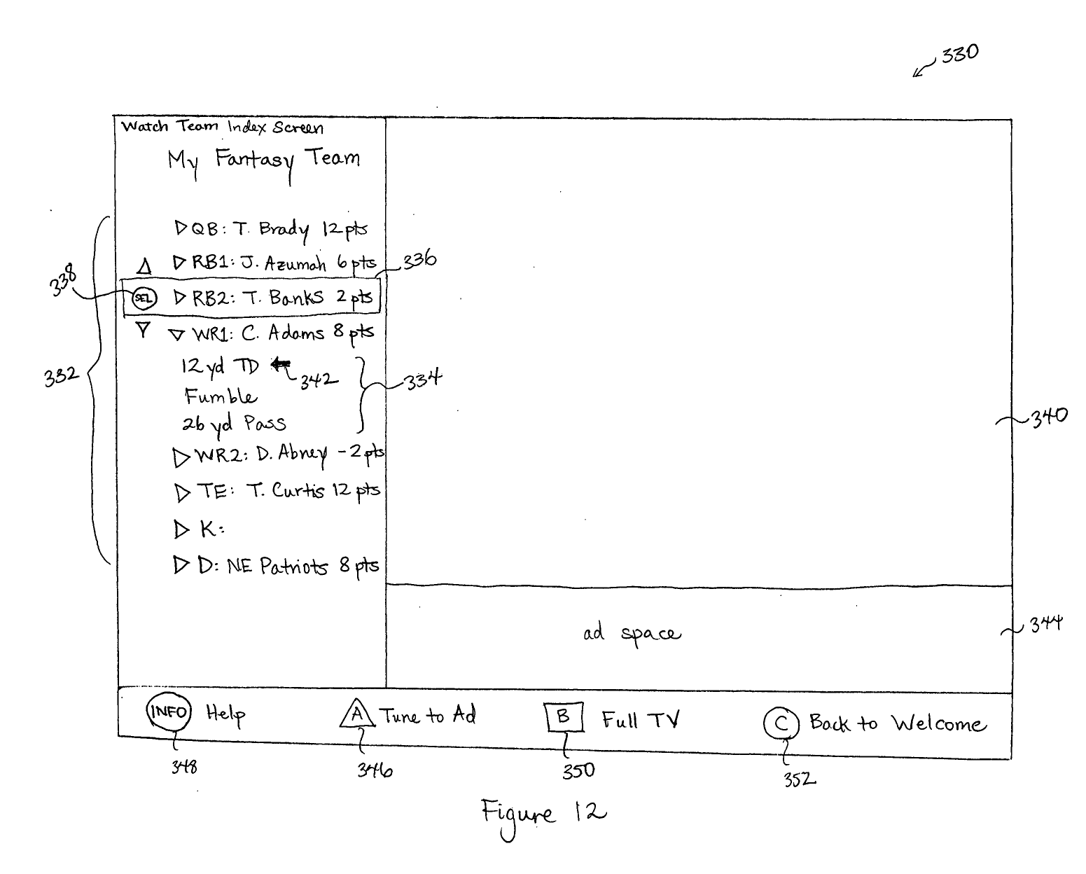

The player guide may also offer the option of visiting a Watch Team Index page 62, as described further in relation to FIG. 12, that displays a segment guide corresponding to a playlist of segments depicting players currently on the user's team roster. This playlist can be generated in response to the user visiting page 62 and by selecting at least one segment related to each player currently on the user's team roster. The segments may also satisfy additional criteria, which may be based on user input. For example, the segments may depict events that earned the highest points for the fantasy sports game, had received the most attention or coverage by the news media, or occurred recently, such as within the past week, in an earlier week of the sports season, throughout the entire season, or only on certain evenings such as Monday night. The user may opt to view the segments of this playlist in a larger screen, such as a Full Screen mode 64, that may or may not display the segment guide. The user may visit the Watch Team Index page 62 from the Welcome page 52, as depicted in FIG. 3, or from other pages of the player guide as well.

FIGS. 4, 6, 8, and 10A-10C depict illustrative screenshots of a player guide such as the one depicted in FIG. 3 for display on a computer screen and/or over the internet. Player guides displayed on a television may look similar to these screenshots, and in particular FIG. 12 shows an illustrative screenshot that may be displayed on a television. FIGS. 5A, 5B, 7, 9, 11A, and 11B depict illustrative screenshots of a player guide such as the one depicted in FIG. 3 for display on a wireless device such as a mobile phone, or any other device having a relatively small screen. Variations of these screenshots that have additional or fewer features, different layouts, interfaces, or navigation options may also constitute a player guide within the scope of this invention.

FIG. 4 depicts an illustrative screenshot of a Welcome page 70, similar to the Welcome page 52 of FIG. 3, of a player guide. The Welcome page 70 may include a user's current team roster 72 for a fantasy sports game, a search box 74 in which the user may enter a search query with which to retrieve segments that satisfy criteria specified by the search query, a video screen 76 which displays video segments, a video screen toolbar 78 comprising options for the current segment being displayed by the video screen 76, a highlight box 80 that highlights an option in a menu (e.g., a position in the current team roster 72), a description box 82 containing a description of either the option currently being highlighted by the highlight box 80 or the segment currently being displayed by the video screen 76, space for advertisements 90, and interface options 84 related to a portal, website, or other platform through which the user is accessing the player guide.

The available positions and players for the team roster 72 can follow the rules of a fantasy sports league that is running the fantasy sports game. The team roster 72 can also show current fantasy point totals 114 for each player on the fantasy team. The user may highlight any available position using the highlight box 80, and select the highlighted box to select and/or update the player occupying that position, which may allow the user to visit a Player Selection page as depicted in FIG. 6. In addition, the user may select any arrow 86 to watch segments related to the player to the right of the arrow, or to access a Watch My Team option 88. The user may also request video segments by entering a search query in the search box 74, then selecting the search button 110 which generates a playlist of segments satisfying criteria specified by the search query. In particular, the segments are associated with attribute data that satisfy the criteria specified by the search query.

The video screen toolbar 78 may include a pause button 92, a previous button 94 which skips to the previous segment, a next button 96 which skips to the next segment, a volume control 98, a progress bar 100 with a moveable tab 102 that depicts how far the video being played has progressed within its segment, an email button 104 for emailing the current segment, a favorites button 106 for adding the current segment to a portion of the user's profile containing the user's favorite segments and/or video programs, and a resize button 108 that allows the user to invoke a Full Screen mode as depicted in FIGS. 10B and 10C.

The other interface options 84 allow the user to visit other webpages such as webpages offering videos related to music, news, sports in general, or entertainment, as depicted in FIG. 4. Alternatively, the other webpages may be related to sports other than the one currently being displayed. The user may also log into the portal, website, or platform, as indicated by the display of the user's username 112, to access personalized information such as the team roster, user profile, user favorites, and/or user preferences.

FIGS. 5A and 5B depict illustrative screenshots of, respectively, a Welcome page 120 and a Fantasy Team page 122 of a player guide that are similar in function to the Welcome page 70 of FIG. 4. These pages may be better adapted for use on smaller screens, such as for a mobile phone 136. From the Welcome page 120 of FIG. 5A, the user may choose a Watch My Team option 124, which is currently highlighted by a highlight box 126, or a Setup option 128 which allows the user to visit Fantasy Team page 122. The user can choose options by scrolling through them, with the current selection being indicated by the highlight box 126. An exit option 130 allows the user to exit the player guide for the fantasy sports league the user is participating in. The Fantasy Team page 122 of FIG. 5B displays a menu comprising the user's current team roster 132, through which the user may scroll using a highlight box 134. Selecting a position from the team roster 132 allows the user to visit a Player Selection page, similar to the one depicted in FIG. 7. Selecting a back option 138 allows the user to return to the Welcome page 120 of FIG. 5A.

FIG. 6 depicts an illustrative screenshot of a Player Selection page 150, similar to the Player Selection page 54 of FIG. 3, of a player guide. The Player Selection page 150 may include a menu 152 of players currently available for a position in the fantasy sports game (e.g., the quarterback in a football game). The menu 152 can also show current fantasy point totals 172 for each player currently available for the position. The user may highlight any available player for the position using a highlight box 154, and select the highlighted box to access playlists related to the highlighted player, which may allow the user to visit a Scout Player page as depicted in FIG. 8. In addition, the user may select any arrow 156 to watch segments related to the player to the right of the arrow. Similar to the Welcome page 70 of FIG. 4, the Player Selection page 150 may include a search box 158, a search button 160, a video screen 162, a video screen toolbar 164, a description box 166, space for advertisements 168, and interface options 170.

FIG. 7 depicts an illustrative screenshot of a Player Selection page 180 of a player guide, which may be better adapted for use on smaller screens, such as for a mobile phone 182. The Player Selection page 180 includes a menu 184 of players currently available for a position in the fantasy sports game (e.g., the quarterback in a football game). The user can choose players in the menu 184 by scrolling through them, with the current selection being indicated by a highlight box 186 and the player currently on the fantasy team roster being indicated by a symbol next to the player's name, such as a checkmark 190. Selecting a player from the menu 184 allows the user to visit a Scout Player page, similar to the one depicted in FIG. 9. Selecting a back option 188 allows the user to return to the Fantasy Team page 122 of FIG. 5B.

FIG. 8 depicts an illustrative screenshot of a Scout Player page 200, similar to the Scout Player page 56 of FIG. 3, of a player guide. The Scout Player page 200 may include a menu 202 of playlists related to the player currently being scouted. A playlist may have segments depicting, for example, highlights from a specific week of the sports season, profile information such as statistics or background, interviews and/or analysis from a specific week of the sports season, or highlights and/or other segments summarizing the player's previous season. The segments selected for the playlists may be customized to the user's preferences. For example, the user may indicate in a user profile a preference to always see segments from SportsCenter but never from practice sessions. The user may highlight any playlist using a highlight box 204, and select the highlighted box to access a segment guide for the highlighted playlist, which may allow the user to visit a Player Playlist Index page as depicted in FIG. 10. In addition, the user may select any arrow 206 to watch segments related to the playlist to the right of the arrow. Similar to the Welcome page 70 of FIG. 4, the Scout Player page 200 may include a search box 208, a search button 210, a video screen 212, a video screen toolbar 214, a description box 216, space for advertisements 218, and interface options 220.

FIG. 9 depicts an illustrative screenshot of a Scout Player page 230 of a player guide, which may be better adapted for use on smaller screens, such as for a mobile phone 232. The Scout Player page 230 includes profile information 234 about the player, for example a photo of the player, the team the player plays for, statistics, and other background information. From this page the user can play a playlist of segments depicting highlights occurring in the most recent week of the sports season and relevant to the fantasy sports game, for example plays that earned the player points in the fantasy sports game. Selecting a back option 236 allows the user to return to the Player Selection page 180 of FIG. 7.

FIGS. 10A, 10B, and 10C depict illustrative screenshots of a player guide playing segments of a playlist. FIG. 10A depicts an illustrative screenshot of a Player Playlist Index page 240, similar to the Player Playlist Index page 58 of FIG. 3. FIGS. 10B and 10C depict illustrative screenshots having a resized video screen, similar to Full Screen mode 60 of FIG. 3.

The Player Playlist Index page 240 of FIG. 10A may include a segment guide 242 of segments in the playlist. The user may highlight a segment in the playlist using a highlight box 244, and select either the highlighted box 244 or any arrow 246 to play the corresponding segment. Similar to the Welcome page 70 of FIG. 4, the Player Playlist Index page 240 may include a search box 248, a search button 250, a video screen 252, a video screen toolbar 254, a description box 256, space for advertisements 258, and interface options 260. The video screen toolbar 254 can have a resize button 262 that allows the user to visit a Full Screen mode as depicted in FIGS. 10B and 10C.

The Full Screen mode 270 of FIG. 10B is similar to the Player Playlist Index page 240 of FIG. 10A, except the video screen 272 is larger than the video screen 252 of FIG. 10A, which may be accomplished by removing the description box and advertisement space. The video screen toolbar 274 may be optionally removable, where the toolbar 274 is not displayed unless the user indicates the video screen 272. The user may return to the previous screen size by indicating a resize button 276 on the video screen toolbar 274, similar to the resize button 262 of FIG. 10A. The Full Screen mode 280 of FIG. 10C has a video screen 282 that covers most of the available screen. A navigation box 284 can include a title 286 identifying the segment currently being played (e.g., the player and the play depicted in the current segment), a back button 288 to allow the user to return to the Player Playlist Index page 240 of FIG. 10A, a previous button 290 which skips to the previous segment, and a next button 292 which skips to the next segment. Other navigation buttons may also be included in the navigation box 284. The navigation box may also be optionally removable, where the navigation box 284 is not displayed unless the user indicates the video screen 282.

FIGS. 11A and 11B depict illustrative screenshots 300 and 302 of a player guide playing segments of a playlist, which may be better adapted for use on smaller screens, such as for a mobile phone 304. The screenshot 300 of FIG. 1 A may be accessed from the Scout Player page 230 of FIG. 9. To maximize the size of the video screen 306, menus such as a segment guide containing the segments of the playlist can not be displayed, and minimal information about the current segment, such as a playlist title 308 and a segment title 310, may be displayed. Selecting a back option 318 allows the user to return to either the Scout Player page 230 of FIG. 9 or the Player Selection Page 180 of FIG. 7. Turning to FIG. 11B, if the user chooses to view a menu, such as the segment guide 312, the video screen 306′ may either be overlaid with the segment guide 312 or slide partially out of view to make room for the segment guide 312, as depicted. The user can choose segments in the segment guide 312 by scrolling through them, with the current selection being indicated by a highlight box 314. Selecting a segment from the segment guide 312 removes the segment guide 312 and plays the selected segment, returning the device to a view similar to the one depicted in FIG. 11A. Selecting a back option 316 allows the user to return to either the Scout Player page 230 of FIG. 9 or the Player Selection Page 180 of FIG. 7.

FIG. 12 depicts an illustrative screenshot of a Watch Team Index page 330 of a player guide, similar to the Watch Team Index page 62 of FIG. 3 and which may be better adapted for use on a television screen. The user may interact with the Watch Team Index page 300, which displays a segment guide corresponding to a playlist of segments depicting players currently on the user's fantasy team roster, via a hand-held remote control unit (or “remote”). User selections can be indicated using the remote, often from menu selections or other visual indicators presented on a conventional television monitor; however, voice commands, touch screens, or other input means, may also be used.

The Watch Team Index page 330 may include an expandable player menu 332, where each option on the player menu 332 includes a player currently on the user's fantasy team roster and can be expanded to display the segments related to that player, as depicted by a segment menu 334. The user may highlight an option in the player menu 332 using a highlight box 336, and either scroll the highlight box 336 up, scroll it down, or select the highlighted option by using a “SEL” button on the remote, as indicated by a SEL button 338 depicted on the page 330. If the selected option contains a player name, the player menu 332 can either expand to display or collapse the segments corresponding to the player. If the selected option contains a segment name, the player guide can play the highlighted segment in a video screen 340, where the segment currently playing can be indicated by an arrow 342 adjacent to the segment name.

The Watch Team Index page 330 may also include space for advertisements 344, which may have accompanying video that can be accessed if the user selects an “A” button on the remote, as indicated by the A button 346 depicted on the page 330. Other buttons that similarly correspond to buttons on the remote include an INFO button 348 which can display a screen for helping a user navigate and use the player guide, a B button 350 for entering a full screen mode similar to the Full Screen mode 64 depicted in FIG. 3, and a C button 352 which can display a welcome page similar to the Welcome page 52 depicted in FIG. 3.

1. A method for enhancing a fantasy sports game with recorded sports broadcasts, comprising
receiving video programs depicting sports-related events,
storing the video programs,
associating to a plurality of segments of the video programs attribute data that identifies for a segment of the plurality of segments at least one of a plurality of persons related to a portion of the sports-related events depicted in the segment of the plurality of segments,
transmitting to a presentation device for display a player guide containing at least one of the plurality of persons,
receiving from a user of the presentation device a video request related to a particular person contained in the player guide,
retrieving from the plurality of segments a particular segment associated with attribute data that identifies the particular person, and
transmitting the particular segment to the presentation device for display.

2. The method of claim 1, comprising storing a team list representing a fantasy sports team formed by the user for the fantasy sports game including at least one of the plurality of persons.

3. The method of claim 2, comprising receiving from the user a selection indicating that the particular person be added to the team list.

4. The method of claim 2, comprising transmitting the team list to a fantasy sports league server operating the fantasy sports game.

5. The method of claim 2, comprising receiving the team list from a fantasy sports league server operating the fantasy sports game.

6. The method of claim 2, comprising
creating a playlist that includes at least one of the plurality of segments, wherein each person on the team list is identified by attribute data associated with at least one segment included in the playlist, and
transmitting to the presentation device for display a segment guide listing the at least one segment included in the playlist.

7. The method of claim 1, comprising
creating a playlist that corresponds to a playlist condition and includes segments of the plurality of segments, wherein the segments included in the playlist are each associated with attribute data that satisfies the playlist condition, and
transmitting to the presentation device for display a segment guide listing the segment included in the playlist.

8. The method of claim 7, comprising
receiving from the user a segment request related to one of the segments listed in the segment guide, and
transmitting to the presentation device for display the segment related to the segment request.

9. The method of claim 7, wherein the playlist condition identifies at least one attribute datum associated with each of the segments included in the playlist.

10. The method of claim 7, comprising receiving from the user a playlist request, wherein the playlist condition is based on the playlist request.

11. The method of claim 7, comprising storing user preferences, wherein the playlist condition is based on the user preferences.

12. The method of claim 1 1, wherein the user preferences indicate a ranking of sports-related events.

13. The method of claim 1, comprising storing video programs having attribute data associated to segments of the video programs at a rate of about once a week during a sports season corresponding to the fantasy sports game.

14. The method of claim 1, wherein the particular person is at least one of participating, speaking, and being mentioned, during that portion of the sports-related event depicted in the particular segment.

15. The method of claim 1, wherein the sports-related event is at least one of a live sports game, a sports news show, a sports analysis show, an interview, a pre-game show, a post-game show, and a sports practice session.

16. The method of claim 1, wherein the attribute data identifies at least one of a title of the segment, a team name, a second particular person related to that portion of the sports-related event depicted in the segment, a date when the sports-related event occurred, a time period in which that portion of the sports-related event depicted in the segment occurred, an event that occurs during that portion of the sports-related event depicted in the segment, and a number representing points corresponding to a person related to that portion of the sports-related event depicted in the segment, the points corresponding to the fantasy sports game.

17. The method of claim 1, wherein the sports-related event is related to at least one of football, baseball, basketball, hockey, golf, tennis, soccer, and auto racing.

18. The method of claim 1, wherein the fantasy sports game simulates at least one of a sports game, a draft for a sports league, and a video game.

19. The method of claim 1, wherein the player guide contains descriptions relevant to the persons related to the sports-related events.

20. The method of claim 19, wherein the descriptions include at least one of sports statistics, position played, team played on, points corresponding to the fantasy sports game, and playlists available for displaying on the presentation device.

21. The method of claim 1, wherein the video programs are stored in a storage device of a particular type including at least one of a cable television headend, an internet accessible database, a mobile phone network accessible database, a personal video recorder, and a hard disk drive.

22. The method of claim 21, wherein the video programs are stored in a plurality of storage devices of the particular type.

23. The method of claim 21, wherein the video programs are stored in a plurality of storage devices of a plurality of particular types.

24. A method for enhancing a fantasy sports game with recorded sports broadcasts, comprising
selecting a particular person from a plurality of persons each eligible for inclusion in a team list that represents a fantasy sports team formed for the fantasy sports game,
retrieving at least one segment from a plurality of segments of a video program associated with attribute data, wherein the at least one segment is associated with attribute data identifying the particular person and the video program depicts events related to the fantasy sports game, and
displaying the at least one segment to a user participating in the fantasy sports game.

25. The method of claim 24, comprising
receiving from the user a video request related to the fantasy sports game,
retrieving particular segments of the plurality of segments, wherein the particular segments are each associated with attribute data that satisfy the video request,
ordering the particular segments according to a predetermined ranking to generate a playlist of the particular segments,
displaying to the user a segment guide including the playlist of the particular segments and attribute data associated with the particular segments,
receiving from the user a segment request corresponding to one of the particular segments, and
displaying the one of the particular segments corresponding to the segment request.
